(19) United States
(12) Patent Application Publication
(10) Pub. No.: US 2026/0270744 A1
(43) Pub. Date: Sep. 10, 2026

(54) MULTI-AGENT DISCOVERY

(71) Applicant: Nokia Technologies Oy, Espoo (FI)

(72) Inventors: Jianguo LIU, Shanghai (CN); Zhijie YANG, Shanghai (CN); Yan MENG, Shanghai (CN); Tao TAO, Shanghai (CN); Wenjian WANG, Shanghai (CN)

(21) Appl. No.: 18/847,475

(22) PCT Filed: Mar. 16, 2022
(86) PCT No.: PCT/CN2022/081194

§ 371 Date: Sep. 16, 2024

(51) Int. Cl. H04W 24/10

(52) U.S. Cl. CPC H04W 24/10

(57) ABSTRACT

Embodiments of the present disclosure relate to methods, devices, apparatuses, and computer readable medium for multi-agent discovery. The method comprises: transmitting, to a first device, a first request for the first device to transmit an uplink signal in a front haul link, the front haul link being a radio link between a terminal device and an access point, AP, device. The first request comprises a first indication of creating a temporary terminal device identity. The method comprises transmitting, to a second device, a second request for measuring the front haul link. The method further comprises receiving a front haul link measurement report from the second device, and scheduling a communication resource for the first device and the second device based on the front link measurement report.

### FIELD

Embodiments of the present disclosure generally relate to the field of telecommunication and in particular, to devices, methods, apparatus and computer readable storage media of multi-agent discovery.

### BACKGROUND

With the development of communication technology, in order to meet the coverage performance in different radio environments, multi-Access Point (AP) deployment has been introduced. In the multi-AP deployment, a terminal device/user equipment/mobile station may connect to a data network via a Virtual Basic Service Set (VBSS) network constituted by multi-AP agents and a multi-AP controller. The VBSS allows the Basic Service Set (BSS) context to be moved from one AP to another or from one band to another, such that the terminal device can be transitioned from one AP to another or from one band to another based on a make before break (MBB) technology without needing to re-associate or re-negotiate security to move the device. In this way, the terminal device can always be connected to the best AP and/or band by continuous passive monitoring of the terminal device connection (signal qualities between the terminal device and the available APs), without incurring the handoff cost of re-association or re-negotiation of security. Along with the benefits of multi-AP deployment, there may be also occurring interferences and/or conflicts between APs in the multi-AP deployment. Further, the solution for coordinating potentially interference/conflict between APs is also a key aspect.

### SUMMARY

In general, example embodiments of the present disclosure provide a solution for multi-agent discovery.

In a first aspect, there is provided an apparatus. The apparatus comprises: at least one processor; and at least one memory storing instructions. The at least one memory storing instructions that, when executed by the at least one processor, cause the apparatus at least to: transmit, to a first device, a first request for the first device to transmit an uplink signal in a front haul link, the front haul link being a radio link between a terminal device and an access point, AP, device. The first request comprises a first indication of creating a temporary terminal device identity. The apparatus is further caused to transmit, to a second device, a second request for measuring the front haul link; receive, from the second device, a front haul link measurement report; and schedule a communication resource for the first device and the second device based on the front link measurement report.

In a second aspect, there is provided an apparatus. The apparatus comprises: at least one processor; and at least one memory storing instructions. The at least one memory storing instructions that, when executed by the at least one processor, cause the apparatus at least to: receive, from a first device, a first request for the apparatus to transmit an uplink signal in a front haul link, the front haul link being a radio link between a terminal device and an access point device. The first request comprises a first indication of creating a temporary terminal device identity. The apparatus is further caused to transmit, based on the first request, the uplink signal in the front haul link.

In a third aspect, there is provided an apparatus. The apparatus comprises: at least one processor; and at least one memory storing instructions. The at least one memory storing instructions that, when executed by the at least one processor, cause the apparatus at least to: receive, from a first device, a first request for measuring a front haul link, the front haul link being a radio link between a terminal device and an access point device. The apparatus is further caused to determine, based on the first request, a front haul link measurement report; and transmit, to the first device, the front haul link measurement report.

In a fourth aspect, there is provided a method. The method comprises: transmitting, to a first device, a first request for the first device to transmit an uplink signal in a front haul link, the front haul link being a radio link between a terminal device and an access point, AP, device. The first request comprises a first indication of creating a temporary terminal device identity. The method comprises transmitting, to a second device, a second request for measuring the front haul link. The method comprises receiving, from the second device, a front haul link measurement report; and scheduling a communication resource for the first device and the second device based on the front link measurement report.

In a fifth aspect, there is provided a method. The method comprises: receiving, from a first device, a first request for the apparatus to transmit an uplink signal in a front haul link, the front haul link being a radio link between a terminal device and an access point device. The first request comprises a first indication of creating a temporary terminal device identity. The method comprises transmitting, based on the first request, the uplink signal in the front haul link.

In a sixth aspect, there is provided a method. The method comprises: receiving, from a first device, a first request for measuring a front haul link, the front haul link being a radio link between a terminal device and an access point device; determining, based on the first request, a front haul link measurement report; and transmitting, to the first device, the front haul link measurement report.

In a seventh aspect, there is provided an apparatus. The apparatus comprises means for transmitting, to a first device, a first request for the first device to transmit an uplink signal in a front haul link, the front haul link being a radio link between a terminal device and an access point, AP, device. The first request comprises a first indication of creating a temporary terminal device identity. The apparatus comprises means for transmitting, to a second device, a second request for measuring the front haul link; means for receiving, from the second device, a front haul link measurement report; and means for scheduling a communication resource for the first device and the second device based on the front link measurement report.

In an eighth aspect, there is provided an apparatus. The apparatus comprises means for receiving, from a first device, a first request for the apparatus to transmit an uplink signal in a front haul link, the front haul link being a radio link between a terminal device and an access point device; and means for transmitting, based on the first request, the uplink signal in the front haul link. The first request comprises a first indication of creating a temporary terminal device identity.

In a ninth aspect, there is provided an apparatus. The apparatus comprises means for receiving, from a first device, a first request for measuring a front haul link, the front haul link being a radio link between a terminal device and an access point device. The apparatus comprises means for determining, based on the first request, a front haul link measurement report; and means for transmitting, to the first device, the front haul link measurement report.

In a tenth aspect, there is provided a non-transitory computer readable medium. The non-transitory computer readable medium comprises program instructions for causing an apparatus to perform the method according to any of the fourth to sixth aspects.

In a eleventh aspect, there is provided a system comprising the apparatus of the first aspect, the apparatus of the second aspect and the apparatus of the third aspect.

It is to be understood that the summary section is not intended to identify key or essential features of embodiments of the present disclosure, nor is it intended to be used to limit the scope of the present disclosure. Other features of the present disclosure will become easily comprehensible through the following description.

### BRIEF DESCRIPTION OF THE DRAWINGS

Some example embodiments will now be described with reference to the accompanying drawings, where:

FIG. 1 illustrates an example network environment in which example embodiments of the present disclosure may be implemented;

FIG. 2 shows a signaling process for multi-agent discovery according to some example embodiments of the present disclosure;

FIG. 3 illustrates a flowchart of an example method implemented in an apparatus according to example embodiments of the present disclosure;

FIG. 4 illustrates a flowchart of an example method implemented in an apparatus according to example embodiments of the present disclosure;

FIG. 5 illustrates a flowchart of an example method implemented in an apparatus according to example embodiments of the present disclosure; and

FIG. 6 illustrates a block diagram of an example computer readable medium in accordance with example embodiments of the present disclosure.

Throughout the drawings, the same or similar reference numerals represent the same or similar element.

### DETAILED DESCRIPTION

Principles of the present disclosure will now be described with reference to some example embodiments. It is to be understood that these embodiments are described only for the purpose of illustration and help those skilled in the art to understand and implement the present disclosure, without suggesting any limitation as to the scope of the disclosure. The disclosure described herein can be implemented in various manners other than the ones described below.

In the following description and claims, unless defined otherwise, all technical and scientific terms used herein have the same meaning as commonly understood by one of ordinary skills in the art to which this disclosure belongs.

References in the present disclosure to “one embodiment,” “an embodiment,” “an example embodiment,” and the like indicate that the embodiment described may include a particular feature, structure, or characteristic, but it is not necessary that every embodiment includes the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

It shall be understood that although the terms “first” and “second” etc. may be used herein to describe various elements, these elements should not be limited by these terms. These terms are only used to distinguish one element from another. For example, a first element could be termed a second element, and similarly, a second element could be termed a first element, without departing from the scope of example embodiments. As used herein, the term “and/or” includes any and all combinations of one or more of the listed terms.

The terminology used herein is for the purpose of describing particular embodiments only and is not intended to be limiting of example embodiments. As used herein, the singular forms “a”, “an” and “the” are intended to include the plural forms as well, unless the context clearly indicates otherwise. It will be further understood that the terms “comprises”, “comprising”, “has”, “having”, “includes” and/or “including”, when used herein, specify the presence of stated features, elements, and/or components etc., but do not preclude the presence or addition of one or more other features, elements, components and/or combinations thereof.

As used in this application, the term “circuitry” may refer to one or more or all of the following:
(a) hardware-only circuit implementations (such as implementations in only analog and/or digital circuitry) and
(b) combinations of hardware circuits and software, such as (as applicable):
   (i) a combination of analog and/or digital hardware circuit(s) with software/firmware and
   (ii) any portions of hardware processor(s) with software (including digital signal processor(s)), software, and memory(ies) that work together to cause an apparatus, such as a mobile phone or server, to perform various functions) and
(c) hardware circuit(s) and or processor(s), such as a microprocessor(s) or a portion of a microprocessor(s), that requires software (e.g., firmware) for operation, but the software may not be present when it is not needed for operation.

This definition of circuitry applies to all uses of this term in this application, including in any claims. As a further example, as used in this application, the term circuitry also covers an implementation of merely a hardware circuit or processor (or multiple processors) or portion of a hardware circuit or processor and its (or their) accompanying software and/or firmware. The term circuitry also covers, for example and if applicable to the particular claim element, a baseband integrated circuit or processor integrated circuit for a mobile device or a similar integrated circuit in server, a cellular network device, or other computing or network device.

As used herein, the term “communication network” refers to a network following any suitable communication standards, such as Long Term Evolution (LTE), LTE-Advanced (LTE-A), Wideband Code Division Multiple Access (WCDMA), High-Speed Packet Access (HSPA), Narrow Band Internet of Things (NB-IoT), Wi-Fi and so on. Furthermore, the communications between a terminal device and a network device in the communication network may be performed according to any suitable generation communication protocols, including, but not limited to, the first generation (1G), the second generation (2G), 2.5G, 2.75G, the third generation (3G), the fourth generation (4G), 4.5G, the fifth generation (5G), a further sixth generation (6G) communication protocols, and/or any other protocols either currently known or to be developed in the future. Embodiments of the present disclosure may be applied in various communication systems. Given the rapid development in communications, there will of course also be future type communication technologies and systems with which the present disclosure may be embodied. It should not be seen as limiting the scope of the present disclosure to only the aforementioned system.

As used herein, the term “network device” refers to a node in a communication network via which a terminal device accesses the network and receives services therefrom. The network device may refer to a base station (BS) or an access point (AP), for example, a node B (NodeB or NB), an evolved NodeB (eNodeB or eNB), a NR Next Generation NodeB (gNB), a Remote Radio Unit (RRU), a radio header (RH), a remote radio head (RRH), Integrated Access and Backhaul (IAB) node, a relay, a low power node such as a femto, a pico, and so forth, depending on the applied terminology and technology. The network device is allowed to be defined as part of a gNB such as for example in CU/DU split in which case the network device is defined to be either a gNB-CU or a gNB-DU.

The term “terminal device” refers to any end device that may be capable of wireless communication. By way of example rather than limitation, a terminal device may also be referred to as a communication device, user equipment (UE), a Subscriber Station (SS), a Portable Subscriber Station, a Mobile Station (MS), or an Access Terminal (AT). The terminal device may include, but not limited to, a mobile phone, a cellular phone, a smart phone, voice over IP (VoIP) phones, wireless local loop phones, a tablet, a wearable terminal device, a personal digital assistant (PDA), portable computers, desktop computer, image capture terminal devices such as digital cameras, gaming terminal devices, music storage and playback appliances, vehicle-mounted wireless terminal devices, wireless endpoints, mobile stations, laptop-embedded equipment (LEE), laptop-mounted equipment (LME), USB dongles, smart devices, wireless customer-premises equipment (CPE), an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. In the following description, the terms “terminal device”, “communication device”, “terminal”, “user equipment” and “UE” may be used interchangeably.

As mentioned above, there may be also some interferences or conflicts between APs in the multi-AP deployment in addition to the benefits of enhancing coverage performance. For example, there may be a “hidden AP (node) problem”. As discussed above, the multi-AP controller in the VBSS may select the best AP to communicate with a terminal device by continuous passive monitoring of the terminal device connection (e.g., the signal qualities between the terminal device and the APs in the VBSS). However, since the APs only communicate with each other via a wire back haul link or the wireless back haul link working in a band different from a front haul link (between the terminal device and APs), if the serving AP of the terminal device, which is communicating with the terminal device, cannot sense the front haul link transmissions from other AP(s) in the same VBSS to this or other terminal device nearby, the terminal device may suffer from severe interference from another AP in this VBSS. For example, the distance between the two network devices is too large to perform Energy Detection (ED)-based Clear Channel Assessment (CCA), while the terminal device is located in a position between these two network devices. In this case, the other APs nearby which cannot be sensed by the serving AP are the hidden APs for the serving AP.

One solution for overcoming the interference between APs in the multi-AP deployment is that of introducing specific signaling “Request to Send (RTS)” and “Clear to Send (CTS)”. The AP wishing to perform a transmission may firstly send an RTS frame to a target AP. If the channel is clear, the target AP responds with a CTS frame that not only informs the AP wishing to perform the transmission that it may transmit but also tells other APs to refrain from using the channel for a specified amount of time. Although the CTS/RTS can be applied to avoid the strong interference from the hidden node of the serving AP, it's obvious that the RTS/CTS mechanism would add overhead and latency to the transmission process. Therefore, the CTS/RTS mechanism is normally used to protect longer frames which are more expensive to retransmit. However, the RTS/CTS mechanism does not completely solve the hidden node problem as the hidden node still exists. Actually, the RTS/CTS mechanism simply suppresses the transmission of neighboring APs in the same channel, but the actual radio conditions of inter APs in the multi-AP deployment cannot be accurately measured. Further, multi-AP discovery is a key aspect for coordinating potentially interference/confliction between APs.

Example embodiments of the present disclosure provide a scheme for multi-agent discovery. In this scheme, an apparatus transmits to the first device (for example, a first AP device) a first request for a first device to transmit an uplink signal in a front haul link, the front haul link is a radio link between a terminal device and an AP device and the first request comprises a first indication of creating a temporary terminal device identity. The apparatus transmits a second request for measuring the front haul link to a second device (for example, a second AP device). Then, the apparatus receives a front haul link measurement report from the second device, and schedules a communication resource for the first device and the second device based on the front link measurement report. It is to be understood that the communication resource comprises any of time domain resource, frequency domain resource, code domain resource, spatial domain resource, polarization domain resource and other communication resources.

In this way, the front haul link interference between APs in a multi-AP deployment can be measured accurately. Further, a hidden AP(s) of a serving AP may be discovered and coordinated in advance.

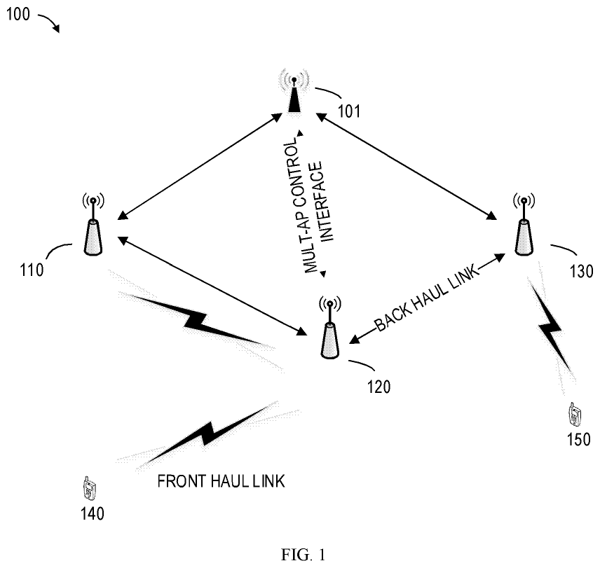

FIG. 1 illustrates an example network environment 100 in which embodiments of the present disclosure can be implemented.

The environment 100, which may be a part of a data communication network, comprises a first network device 101, a second network device 110, a third network device 120, a fourth network device 130, a first terminal device 140 and a second terminal device 150. In the environment 100, the second, third and fourth network devices 110, 120 and 130 may communicate with each other in wired or wireless back haul link in a channel/band which is different from the channel/band of a front haul link between the terminal devices 140, 150 and the network devices 110, 120 and 130. The first network device 101 may communicate with the second, third and fourth network devices 110, 120 and 130 via a multi-AP control interface. The terminal devices 140 and 150 may connect to a data network via the front haul link between the terminal devices and these network devices 110, 120 and 130.

For example, the terminal device 140 may communicate with the second network device 110 and/or the third network device 120 on uplink (UL) or downlink (DL). In particular, the direction from the terminal device 140 to the second network device 110 and/or the third network device 120 refers to UL, and the direction from the second network device 110 and/or the third network device 120 to the terminal device 110 refers to DL.

Only for ease of discussion, the terminal device is illustrated as a UE, and the first network devices are illustrated as base stations. However, the UE and base station are only given as example implementations of the terminal devices, and the network devices, respectively, without suggesting any limitation as to the scope of the present application. Any other suitable implementations are possible as well.

It is also to be understood that the number of the devices as shown in FIG. 1 are only for the purpose of illustration without suggesting any limitations. For example, the environment 100 may include any suitable number of terminal devices and network devices adapted for implementing embodiments of the present disclosure.

The communications in the network environment 100 may conform to any suitable standards including, but not limited to, LTE, LTE-evolution, LTE-advanced (LTE-A), wideband code division multiple access (WCDMA), code division multiple access (CDMA) and global system for mobile communications (GSM), Wi-Fi and the like. Furthermore, the communications may be performed according to any generation communication protocols either currently known or to be developed in the future. Examples of the communication protocols include, but are not limited to, the first generation (1G), the second generation (2G), 2.5G, 2.75G, the third generation (3G), the fourth generation (4G), 4.5G, the fifth generation (5G), and/or any further communication protocols.

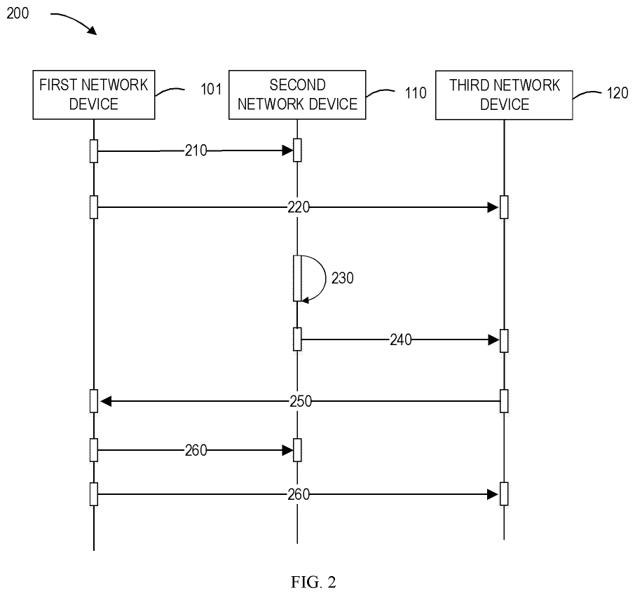

FIG. 2 shows a signaling process 200 for multi-agent discovery according to some example embodiments of the present disclosure. For purpose of discussion, the signaling process 200 will be described with reference to FIG. 1.

For the clarity of discussion, the apparatus for implementing the scheme of multi-AP discovery is discussed with reference to the first network device 101, the second network device 110 and the third network device 120. Without any limitation, in some embodiments, the first network device 101 is a multi-AP controller device, the second network device is an access point and the third network device is another access point device. In some embodiments, the first network device 101 may be contained in the second device 110 or the third device 120.

In the process 200, at step 210, a first network device 101 transmits to a second network device 110 a first request for the second network device 110 to transmit an uplink signal in a front haul link. The front haul link is the radio link between the terminal device 140 and the network devices 101, 110, 120 and 130. The first request comprises a first indication of creating a temporary terminal device identity.

As discussed above, the network devices usually communicate with each other via the back haul link different from the front haul link. For measuring the front haul link quality inter-APs, with the indication of creating the temporary terminal device identity, the first network device 101 may request the second network device 110 to act as a temporary “terminal device”, in order to transmit an uplink signal in the front haul.

For further specifying the uplink signal transmitted by the second network device 110, the first request may comprise other indications regarding the Media Access Control (MAC) address of the temporary terminal device identity, communication channel, signal type, transmission time/window and so on. In some embodiments, in order to retrieve this specific front link quality from a future front haul link measurement report, the first network device 101 may indicate a MAC address for the temporary terminal device identity of the second device 110. For example, the first network device 101 may generate a MAC address randomly and indicate this MAC address to the second device 110 for the temporary terminal device identity. In another example, the first network device 101 may select a MAC address from a MAC address database and indicate the selected MAC address to the second device 110 for the temporary terminal device identity.

In addition or alternatively, the first network device 101 may select a “real” terminal device served by another network device (for example, a third network device 120), and indicate the MAC address of this real terminal device to the second device 110. In some embodiments, the first network device 101 may determine a real terminal device in a de-activated mode, and indicate the MAC address of this real terminal device to the second network device 110. In some embodiments, the first network device 101 may indicate the MAC address to the second network device 110 in other ways.

In some embodiments, the first request may comprise a communication resource indication for the uplink signal. For example, the first request may comprise a channel/band indication. With the channel/band indication, the second network device 110 may transmit the uplink signal in the given channel/band.

In some embodiments, the first request may comprise a signal type indication for the uplink signal. This signal type indication may indicate which type of signal the second network device 110 is to transmit in the front haul link. In addition or alternatively, in some embodiments, the type of signal may further comprise: a probe request frame or a public action frame.

In some embodiments, the first request may comprise a transmission time indication for the uplink signal. The transmission time indication may indicate the time window during which the second network device 110 transmits the uplink signal. As mentioned above, the MAC address for the temporary terminal device identity of the second device 110 may be indicated as the MAC address of a real terminal device. In this case, the time window indicated may be determined based on a Target Wake Time (TWT) of the real terminal device. For example, the first network device 101 may determine the transmission time (time window) as the time during which the real terminal device is in the de-activated mode, sleeping mode or other idle modes other than the TWT.

At step 220, the first device 110 transmits a second request for measuring the front haul link to the third network device 120. In addition, in some embodiments, the second request transmitted by the first network device 101 may comprise the MAC address for the temporary terminal device identity. In some embodiments, the MAC address is determined by the first network device 101. In some embodiments, as discussed below, the MAC address is determined by the second network device 110 and is further transmitted to the first network device 101.

In some embodiments, if the MAC address for the temporary terminal identity of the second network device 101 is configured as the MAC address of a real terminal device served by the third device 120, the first network device 101 may transmit an associated link measurement request message to the second network device 110, since the temporary terminal device identity may be considered by the third network device 120 as an associated terminal device of the third network device 120. In addition or alternatively, in some embodiments, the first device 101 may transmit an unassociated link measurement request message to the second device. In this case, the temporary terminal device identity of the second network device 110 may be a terminal device identity unassociated with the third network device 120.

In addition or alternatively, the first network device 101 may transmit a frame measurement request for the second network device 110 to monitor for a probe request frame or a public action frame.

In some embodiments, if the first request comprises a signal type indication of probe request frame or the public action frame, the first device 101 may configure the third network device 120 to monitor a specific probe request frame or a specific public action frame. In some embodiments, the frame measurement request may indicate the third network device 120 to monitor all probe request frames or public action frames. In addition, the frame type and channel number may be specified in the second request message.

At step 230, after receiving the first request, the second device 110 transmits the uplink signal in the front haul link based on the first request. For example, during the transmission time indicated by the transmission time indication of the first request, the second device 110 (acting as a temporary terminal device with the MAC address indicated by the first request) may transmit the uplink signal (with the signal type indicated by the type indication in the first request) in a given channel/band (indicated by the channel indication in the first request).

In addition, upon receiving the first request, the second device 110 determines whether it has a capability of creating the temporary terminal device identity. In general, most network devices support the capability to create the temporary terminal device identity. In some embodiments, the second device 110 may transmit acknowledge (ACK) message to the first device 101 upon receiving the first request. In an example, the ACK message may comprise an indication as to whether the second network device 110 has a capability of creating the temporary terminal device identity. If the second network device 110 cannot support the capability of creating the temporary terminal device identity, the first device 101 may transmit the first request to another network device (for example, the fourth network device 130).

In addition or alternatively, the second network device 110 may create the temporary terminal device identity by entering/activating a terminal device mode which is pre-set.

In some embodiments, if the first request comprises no indication for the MAC address of the temporary terminal device, the second device 110 may determine the MAC address autonomously. In this case, the second device 110 may transmit the ACK message comprising this MAC address back to the first device 101.

At step 240, the third device 120 determines a front haul link measurement report based on the second request. In some embodiments, the third device 120 performs a measurement on the front links that can be sensed. In some embodiments, the front link measurement may be the RCPI/RSSI/RSRP/SINR measurement which is detected based on the preamble or/and pilot reference signaling transmitted by the temporary/real terminal devices. After the measurement, the third network device 120 may determine the front haul link measurement report which comprises front haul link quality levels corresponding to one or more front haul link that can be sensed by the third network device 120. In some embodiments, the third network device 120 monitors and reports link/RCPI measurement for all the probe requests or public action frames according to the instruction from the first network device 101.

In some embodiments, the front link quality report may comprise at least one of: MAC address of the terminal device: the MAC address for associated terminal device or non-associated terminal device; front link measurement: the link quality between the terminal device and the third network device 120, such as the RCPI; Received Channel Power Indication, for example, which is measured based on the preamble or reference signaling/pilot from the STA; Channel Number: the number of operating channel. In addition or alternatively, the link measurement can also be enclosed in the detection report of uplink frame, e.g. probe request frame, public action frame.

At step 250, the third network device 120 transmits the front haul link measurement to the first network device 101.

At step 260, the first network device 101 schedules a communication resource for the first device and the second device based on the front link measurement report. In some embodiments, the first network device 101 may determine the front haul link quality level between the second network device 110 and the third network device 120. For example, the first network device 101 may retrieve the front haul link quality level from the front link measurement report based on the MAC address for the temporary terminal device identity discussed above. In some embodiments, the first device 101 may also retrieve the front haul link quality level from the front link measurement report based on a specific channel number or specific transmission time.

With the retrieved front haul link quality level, the first network device 101 may perform multi-network devices coordination.

In an example, if the front link quality, for example Received Channel Power Indicator (RCPI), between the second network device 110 and the third network device 120 is less than a first quality threshold and larger than a second quality threshold, the first network device 101 may consider the first network device as a nearby hidden node of the second network device, which means that the second network device may not be able to detect the existence of transmission from the nearby first network device through ED-based CCA. If so, the first network device 101 can schedule a first communication resource for the second network device 110 and a different second communication resource for the third network device 120. For example, the first network device 101 may configure the second network device 110 and the third network device 120 to work in different operating channel for inter-network devices interference coordination.

In addition or alternatively, in another example, if the front link quality, for example RCPI, between the second network device 110 and the third network device 120 is less than the second threshold or the third network device 120 does not discover any uplink signal from the temporary terminal device identity of the second network device 110, the first network device 101 may consider the second network device 110 as a far way hidden node of the third network device 120, which means the third network device 120 may not be able to detect the existence of transmission from the far away second network device 110 through ED-based CCA. If so, the first network device 101 may determine that the transmissions from the network devices 110 and 120 cannot interfere with each other. Then, the first network device 101 may configure the two network devices 110 and 120 to share the same operating channel for resource reuse.

In addition or alternatively, in yet another example, if the front link quality, for example RCPI, between the second network device 110 and the third network device 120 is larger than the first threshold, the first network device 101 may consider the second network device 110 as a potential coordination node of the third network device 120. If so, the first network device 101 may schedule the two network devices 110 and 120 to perform a joint transmission or signal processing to improve the system spectrum efficiency.

As such, with a temporary terminal device created by a AP device, the accurate front link quality between AP devices (for example, the second network device 110 and the third network device 120) can be determined and reported to a multi-AP controller device (for example, the first network device 101). Then, the multi-AP controller device may perform a coordination operation between the AP devices to achieve a better reliability and efficiency performance.

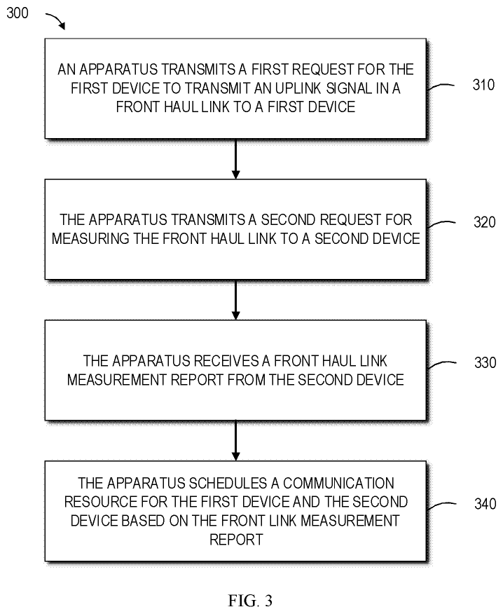

FIG. 3 illustrates a flowchart of an example method 300 implemented in an apparatus according to example embodiments of the present disclosure. The method 300 can be implemented at the first network device 101 shown in FIG. 1. For the purpose of discussion, the method 300 will be described with reference to FIG. 1. It is to be understood that method 300 may further include additional blocks not shown and/or omit some shown blocks, and the scope of the present disclosure is not limited in this regard.

At block 310, the apparatus (for example, the first network device 101) transmits, to a first device (for example, the second network device 110), a first request for the first device to transmit an uplink signal in a front haul link. The front haul link is a radio link between a terminal device and an access point, AP, device. The first request comprises a first indication of creating a temporary terminal device identity.

At block 320, the apparatus transmits, to a second device (for example, the third network device 120), a second request for measuring the front haul link.

At block 330, the apparatus receives, from the second device, a front haul link measurement report.

At block 340, the apparatus schedules a communication resource for the first device and the second device based on the front link measurement report.

In some embodiments, the first request comprises at least one of: a Media Access Control, MAC, address for a temporary terminal device identity of the first device; a communication resource indication for the uplink signal; a signal type indication for the uplink signal; or a transmission time indication for the uplink signal.

In some embodiments, the MAC address is generated by the apparatus randomly or is determined by the apparatus based on at least one of: a MAC address of a terminal device served by the second device; or a MAC address in a MAC address database.

In some embodiments, the MAC address is determined based on the MAC address of the terminal device served by the second device, and the transmission time indication is determined by the apparatus based on a Target Wakeup Time, TWT, of the terminal device served by the second device.

In some embodiments, the method 300 further comprises determining a front haul link quality level between the first device and the second device based on the front link measurement report; and at least one of: in accordance with a determination that the front haul link quality level is between a first quality threshold and a second quality threshold, scheduling a first communication resource for the first device and a different second communication resource for the third device, the first quality threshold being larger than the second quality threshold; in accordance with a determination that the front haul link quality is above the first quality threshold, scheduling the first device and the second device to perform a joint transmission; or in accordance with a determination that the front haul link quality is below the second quality threshold, scheduling the first device and the second device to share the same communication resource.

In some embodiments, the method 300 further comprises receiving, from the first device, a second indication as to whether the first device has a capability of creating temporary terminal device identity.

In some embodiments, the method 300 further comprises the apparatus receives, from the first device, a MAC address for a temporary terminal device identity of the first device.

In some embodiments, the second request comprises a Media Access Control, MAC, address for the temporary terminal device identity, In some embodiments, transmitting the second request is performed by at least one of: transmitting an associated link measurement request message to the second device; transmitting an unassociated link measurement request message to the second device; or transmitting a frame measurement request for the second device to monitor for a probe request frame or a public action frame.

In some embodiments, the apparatus is a multi-access point controller device, the first device is a first AP device, and the second device is a second AP device different from the first AP device.

In some embodiments, the apparatus is contained in the first device or the second device.

In some embodiments, the apparatus comprises an antenna.

In some example embodiments, a second apparatus capable of performing any of the method 300 (for example, the first network device 101) may comprise means for performing the respective steps of the method 300. The means may be implemented in any suitable form. For example, the means may be implemented in a circuitry or software module or a combination thereof.

In some example embodiments, the second apparatus comprises at least one of: means for transmitting, to a first device, a first request for the first device to transmit an uplink signal in a front haul link, the front haul link being a radio link between a terminal device and an access point, AP, device; means for transmitting, to a second device, a second request for measuring the front haul link; means for receiving, from the second device, a front haul link measurement report; and means for scheduling a communication resource for the first device and the second device based on the front link measurement report.

In some embodiments, the second apparatus comprises at least one of: means for determining a front haul link quality level between the first device and the second device based on the front link measurement report; means for, in accordance with a determination that the front haul link quality level is between a first quality threshold and a second quality threshold, scheduling a first communication resource for the first device and a different second communication resource for the third device, the first quality threshold being larger than the second quality threshold; means for, in accordance with a determination that the front haul link quality is above the first quality threshold, scheduling the first device and the second device to perform a joint transmission; or means for, in accordance with a determination that the front haul link quality is below the second quality threshold, scheduling the first device and the second device to share the same communication resource.

In some embodiments, the second apparatus comprises: means for receiving, from the first device, a second indication as to whether the first device has a capability of creating temporary terminal device identity.

In some embodiments, the second apparatus comprises at least one of: means for transmitting an associated link measurement request message to the second device; means for transmitting an unassociated link measurement request message to the second device; or means for transmitting a frame measurement request for the second device to monitor for a probe request frame or a public action frame.

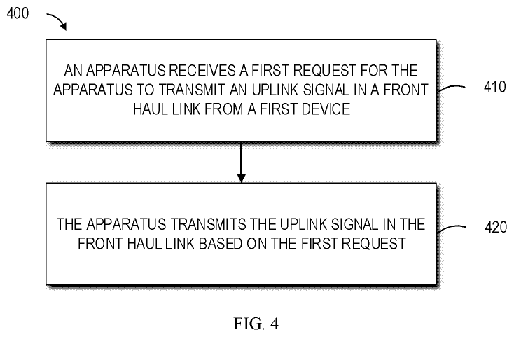

FIG. 4 illustrates a flowchart of an example method 400 implemented in an apparatus according to example embodiments of the present disclosure. The method 400 can be implemented at the second network device 110 shown in FIG. 1. For the purpose of discussion, the method 400 will be described with reference to FIG. 1. It is to be understood that method 400 may further include additional blocks not shown and/or omit some shown blocks, and the scope of the present disclosure is not limited in this regard.

At block 410, an apparatus (for example, the second network device 110) receives, from a first device (for example, the first network device 101), a first request for the apparatus to transmit an uplink signal in a front haul link. The front haul link being a radio link between a terminal device and an access point device. The first request comprises a first indication of creating a temporary terminal device identity.

At block 420, the apparatus transmits, based on the first request, the uplink signal in the front haul link.

In some embodiments, the method 400 further comprises that the apparatus creates a temporary terminal device identity in response to receiving the first request.

In some embodiments, the method 400 further comprises that the apparatus creates the temporary terminal device identity by entering a terminal device mode.

In some embodiments, the method 400 further comprises that in response to receiving the first request, the apparatus transmits a second indication as to whether the apparatus has a capability of creating temporary terminal device identity.

In some embodiments, the method 400 further comprises that the apparatus determines a MAC address for the temporary terminal device identity of the apparatus; and transmits the MAC address to the first device.

In some embodiments, the first request comprises at least one of: a Media Access Control, MAC, address for a temporary terminal device identity of the apparatus; a communication resource indication for the uplink signal; a signal type indication for the uplink signal; and a transmission time indication for the uplink signal.

In some embodiments, the method 400 further comprises that the apparatus transmits the uplink signal by transmitting the uplink signal based on the temporary terminal device identity and the MAC address.

In some embodiments, the apparatus is an access point.

In some embodiments, the apparatus contains the first device.

In some embodiments, the apparatus comprises an antenna.

In some example embodiments, a second apparatus configured to perform any operation(s) of the method 400 (for example, the second network device 110) may comprise means for performing the respective steps of the method 400. The means may be implemented in any suitable form. For example, the means may be implemented in a circuitry or software module or a combination thereof.

In some example embodiments, the second apparatus comprises at least one of: means for receiving, from a first device, a first request for the apparatus to transmit an uplink signal in a front haul link, the front haul link being a radio link between a terminal device and an access point device; or means for transmitting, based on the first request, the uplink signal in the front haul link.

In some embodiments, the second apparatus comprises means for creating a temporary terminal device identity in response to receiving the first request.

In some embodiments, the second apparatus comprises means for creating the temporary terminal device identity by entering a terminal device mode.

In some embodiments, the second apparatus comprises means for determining a MAC address for the temporary terminal device identity of the apparatus; and means for transmitting the MAC address to the first device.

In some embodiments, the second apparatus comprises means for transmitting the uplink signal by transmitting the uplink signal based on the temporary terminal device identity and the MAC address.

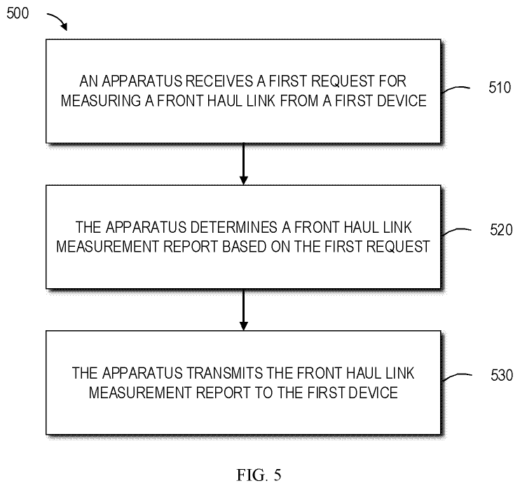

FIG. 5 illustrates a flowchart of an example method 500 implemented in an apparatus according to example embodiments of the present disclosure. The method 500 can be implemented at the third network device 120 shown in FIG. 1. For the purpose of discussion, the method 500 will be described with reference to FIG. 1. It is to be understood that method 500 may further include additional blocks not shown and/or omit some shown blocks, and the scope of the present disclosure is not limited in this regard.

At block 510, an apparatus (for example, the third network device 120) receives, from a first device (for example, the first network device 101), a first request for measuring a front haul link. The front haul link being a radio link between a terminal device and an access point device.

At block 520, the apparatus determines, based on the first request, a front haul link measurement report.

At block 530, the apparatus transmits, to the first device, the front haul link measurement report.

In some embodiments, the method 500 further comprises at least one of: receiving an associated link measurement request message from the first device; receiving an unassociated link measurement request message from the first device; or receiving, from the first device, a frame measurement request for the apparatus to monitor for a probe request frame or a public action frame.

In some embodiments, the apparatus is an access point.

In some embodiments, the apparatus contains the first device.

In some embodiments, the apparatus comprises an antenna.

In some example embodiments, a second apparatus configured to perform any operation(s) of the method 500 (for example, the third network device 120) may comprise means for performing the respective steps of the method 300. The means may be implemented in any suitable form. For example, the means may be implemented in a circuitry or software module or a combination thereof.

In some embodiments, the second apparatus comprises at least one of: means for receiving an associated link measurement request message from the first device; or means for receiving an unassociated link measurement request message from the first device.

In some example embodiments, there is provided a communication system comprising the apparatuses of the methods 300, 400 and 500.

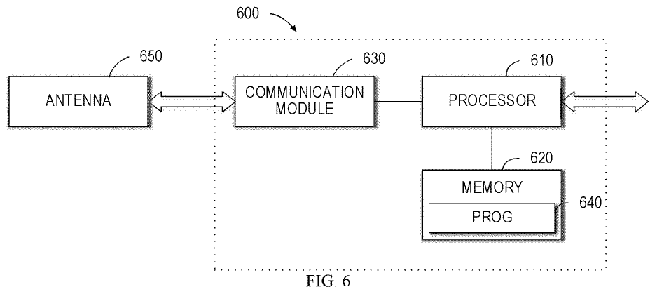

FIG. 6 is a simplified block diagram of a device 600 that is suitable for implementing example embodiments of the present disclosure. The device 600 can be implemented at the first, second and third network devices 101, 110 and 120 as shown in FIG. 1.

As shown, the device 600 includes, without limitation, means as follows: a processor 610, a memory 620 coupled to the processor 610, a communication module 630 coupled to the processor 610, and a communication interface (not shown) coupled to the communication module 630. The memory 620 stores at least a program 640. The communication module 630 is for bidirectional communications, for example, via one or more antennas 650 included in the apparatus described herein, or via a cable. The communication interface may represent any interface that is necessary for communication.

The program 640 is assumed to include program instructions that, when executed by the associated processor 610, enable the device 600 to operate in accordance with the example embodiments of the present disclosure, as discussed herein with reference to FIG. 2 to FIG. 5. The example embodiments herein may be implemented by computer software executable by the processor 610 of the device 600, or by hardware, or by a combination of software and hardware. The processor 610 may be configured to implement various example embodiments of the present disclosure.

The memory 620 may be of any type suitable to the local technical network and may be implemented using any suitable data storage technology, such as a non-transitory computer readable storage medium, semiconductor based memory devices, magnetic memory devices and systems, optical memory devices and systems, fixed memory and removable memory, as non-limiting examples. While only one memory 620 is shown in the device 600, there may be several physically distinct memory modules in the device 400. The processor 610 may be of any type suitable to the local technical network, and may include one or more of general purpose computers, special purpose computers, microprocessors, digital signal processors (DSPs) and processors based on multicore processor architecture, as non-limiting examples. The device 600 may have multiple processors, such as an application specific integrated circuit chip that is slaved in time to a clock which synchronizes the main processor.

When the device 600 acts as the network device 101, 110 or 120, the processor 610 may implement the operations or acts of the network device 101, 110 or 120 as described above with reference to FIG. 2. All operations and features as described above with reference to FIG. 1 to FIG. 5 are likewise applicable to the device 600 and have similar effects. For the purpose of simplification, the details will be omitted.

Various embodiments of the present disclosure may be implemented in hardware or special purpose circuits, software, logic or any combination thereof. Some aspects may be implemented in hardware, while other aspects may be implemented in firmware or software which may be executed by a controller, microprocessor or other computing device. While various aspects of embodiments of the present disclosure are illustrated and described as block diagrams, flowcharts, or using some other pictorial representations. It is to be understood that the block, device, system, technique or method described herein may be implemented in, as non-limiting examples, hardware, software, firmware, special purpose circuits or logic, general purpose hardware or controller or other computing devices, or some combination thereof.

The present disclosure also provides at least one computer program product tangibly stored on a non-transitory computer readable storage medium. The computer program product includes computer-executable instructions, such as those included in program modules, being executed in a device on a target real or virtual processor, to carry out, individually or in combination, the methods 300, 400 or 500 as described above with reference to FIG. 3-FIG. 5. Generally, program modules may include routines, programs, libraries, objects, classes, components, data structures, or the like that perform particular tasks or implement particular abstract data types. The functionality of the program modules may be combined or split between program modules as desired in various embodiments. Machine-executable instructions for program modules may be executed within a local or distributed device. In a distributed device, program modules may be located in both local and remote storage media.

Program code for carrying out methods of the present disclosure may be written in any combination of one or more programming languages. These program codes may be provided to a processor or controller of a general purpose computer, special purpose computer, or other programmable data processing device, such that the program codes, when executed by the processor or controller, cause the functions/operations specified in the flowcharts and/or block diagrams to be implemented. The program code may execute entirely on a machine, partly on the machine, as a stand-alone software package, partly on the machine and partly on a remote machine or entirely on the remote machine or server.

In the context of the present disclosure, the computer program codes or related data may be carried by any suitable carrier to enable the device, device or processor to perform various processes and operations as described above. Examples of the carrier include a signal, computer readable medium, and the like.

The computer readable medium may be a computer readable signal medium or a computer readable storage medium. A computer readable medium may include but not limited to an electronic, magnetic, optical, electromagnetic, infrared, or semiconductor system, device, or device, or any suitable combination of the foregoing. More specific examples of the computer readable storage medium would include an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing.

Further, while operations are depicted in a particular order, this should not be understood as requiring that such operations be performed in the particular order shown or in sequential order, or that all illustrated operations be performed, to achieve desirable results. In certain circumstances, multitasking and parallel processing may be advantageous. Likewise, while several specific implementation details are contained in the above discussions, these should not be construed as limitations on the scope of the present disclosure, but rather as descriptions of features that may be specific to particular embodiments. Certain features that are described in the context of separate embodiments may also be implemented in combination in a single embodiment. Conversely, various features that are described in the context of a single embodiment may also be implemented in multiple embodiments separately or in any suitable sub-combination.

Although the present disclosure has been described in languages specific to structural features and/or methodological acts, it is to be understood that the present disclosure defined in the appended claims is not necessarily limited to the specific features or acts described above. Rather, the specific features and acts described above are disclosed as example forms of implementing the claims.

1-35. (canceled)

36. An apparatus, comprising:
at least one processor; and
at least one memory storing instructions,
the at least one memory storing instructions that, when executed by the at least one processor, cause the apparatus at least to:
transmit, to a first device, a first request for the first device to transmit an uplink signal in a front haul link, the front haul link being a radio link between a terminal device and an access point, AP, device, the first request comprising a first indication of creating a temporary terminal device identity;
transmit, to a second device, a second request for measuring the front haul link;
receive, from the second device, a front haul link measurement report; and
schedule a communication resource for the first device and the second device based on the front link measurement report.

37. The apparatus of claim 36, wherein the first request comprises at least one of:
a Media Access Control, MAC, address for a temporary terminal device identity of the first device;
a communication resource indication for the uplink signal;
a signal type indication for the uplink signal; or
a transmission time indication for the uplink signal.

38. The apparatus of claim 37, wherein the MAC address is generated by the apparatus randomly or is determined by the apparatus based on at least one of:
a MAC address of a terminal device served by the second device; or
a MAC address in a MAC address database.

39. The apparatus of claim 36, further configured to receive, from the first device, a MAC address for a temporary terminal device identity of the first device.

40. The apparatus of claim 36, configured to transmit the second request by at least one of:
transmitting an associated link measurement request message to the second device;
transmitting an unassociated link measurement request message to the second device; or
transmitting a frame measurement request for the second device to monitor for a probe request frame or a public action frame.

41. The apparatus of claim 36, wherein the apparatus is a multi-access point controller device, the first device is a first AP device, and the second device is a second AP device different from the first AP device.

42. The apparatus of claim 36, wherein the apparatus comprises an antenna.

43. An apparatus, comprising:
at least one processor; and
at least one memory storing instructions that, when executed by the at least one processor, cause the apparatus at least to:
receive, from a first device, a first request for the apparatus to transmit an uplink signal in a front haul link, the front haul link being a radio link between a terminal device and an access point device, the first request comprising a first indication of creating a temporary terminal device identity; and
transmit, based on the first request, the uplink signal in the front haul link.

44. The apparatus of claim 43, further configured to create a temporary terminal device identity in response to receiving the first request.

45. The apparatus of claim 43, further configured to:
determine a MAC address for the temporary terminal device identity of the apparatus; and
transmit the MAC address to the first device.

46. The apparatus of claim 43, wherein the first request comprises at least one of:
a Media Access Control, MAC, address for a temporary terminal device identity of the apparatus;
a communication resource indication for the uplink signal;
a signal type indication for the uplink signal; or
a transmission time indication for the uplink signal.

47. The apparatus of claim 43, wherein at least one of the following is true:
the apparatus is an access point device;
the apparatus contains the first device; or
the apparatus comprises an antenna.

48. An apparatus, comprising:
at least one processor; and
at least one memory storing instructions that, when executed by the at least one processor, cause the apparatus at least to:
receive, from a first device, a first request for measuring a front haul link, the front haul link being a radio link between a terminal device and an access point device;
determine, based on the first request, a front haul link measurement report; and
transmit, to the first device, the front haul link measurement report.

49. The apparatus of claim 48, configured to receive the first request by at least one of:
receiving an associated link measurement request message from the first device;
receiving an unassociated link measurement request message from the first device; or
receiving, from the first device, a frame measurement request for the apparatus to monitor for a probe request frame or a public action frame.

50. The apparatus of claim 48, wherein at least one of the following is true:
the apparatus is an access point device;
the apparatus contains the first device; or the apparatus comprises an antenna.

51. A system, comprising the apparatus of claim 36, the apparatus of claim 43 and the apparatus of claim 48.

52. A method, comprising:
transmitting, to a first device, a first request for the first device to transmit an uplink signal in a front haul link, the front haul link being a radio link between a terminal device and an access point, AP, device, the first request comprising a first indication of creating a temporary terminal device identity;
transmitting, to a second device, a second request for measuring the front haul link;
receiving, from the second device, a front haul link measurement report; and
scheduling a communication resource for the first device and the second device based on the front link measurement report.

53. A method, comprising:
receiving, from a first device, a first request for the apparatus to transmit an uplink signal in a front haul link, the front haul link being a radio link between a terminal device and an access point device, the first request comprising a first indication of creating a temporary terminal device identity; and
transmitting, based on the first request, the uplink signal in the front haul link.

54. A method, comprising:
receiving, from a first device, a first request for measuring a front haul link, the front haul link being a radio link between a terminal device and an access point device;
determining, based on the first request, a front haul link measurement report; and
transmitting, to the first device, the front haul link measurement report.

55. A non-transitory computer readable medium comprising program instructions for causing an apparatus to perform at least one of the methods of claim 52, claim 53 or claim 54.
